(19) United States
(12) Patent Application Publication
(10) Pub. No.: US 2022/0197396 A1
(43) Pub. Date: Jun. 23, 2022

(54) DISPLAY DEVICE, DISPLAY METHOD, AND RECORDING MEDIUM RECORDING DISPLAY PROGRAM

(71) Applicant: SHARP KABUSHIKI KAISHA, Sakai City (JP)

(72) Inventor: KOICHI SUGIYAMA, Sakai City (JP)

(21) Appl. No.: 17/549,773

(22) Filed: Dec. 13, 2021

(30) Foreign Application Priority Data
Dec. 17, 2020 (JP) 2020-209252

(51) Int. Cl. G06F 3/01

(52) U.S. Cl. CPC G06F 3/017; G06F 3/011

(57) ABSTRACT

A display device includes: a gesture operation detector that detects a predetermined gesture operation of a user; an operation area setter that sets, when the gesture operation detector detects a first gesture operation of the user, an area associated with the first gesture operation, as a virtual operation area that accepts an input operation of the user directed to the display screen; an input operation detector that detects the input operation of the user; and an input processor that executes, when the input operation detector detects the input operation of the user in the virtual operation area set by the operation area setter, input processing according to the input operation of the user directed to the display screen.

### INCORPORATION BY REFERENCE

This application is based upon and claims the benefit of priority from the corresponding Japanese Patent Application No. 2020-209252 filed on Dec. 17, 2020, the entire contents of which are incorporated herein by reference.

### BACKGROUND

The present disclosure relates to a display device, a display method, and a recording medium recording a display program that accept a non-contact input operation of a user directed to a display screen.

Conventionally, display devices capable of performing an input operation (screen operation) such as an instruction operation without contacting a display screen of a display panel are known. For example, there is known a system in which an operator's skeleton is acquired based on captured image data, a rectangular virtual touch panel (virtual operation area) is set based on skeletal information, and an operator's input operation is accepted.

However, in the conventional technique, since a virtual operation area is automatically set based on skeletal information, the user cannot designate and set the virtual operation area by himself or herself. This causes a problem that operability of an input operation is poor.

### SUMMARY

An object of the present disclosure is to provide, in a display device that accepts a non-contact input operation of a user directed to a display screen, a display device, a display method, and a recording medium recording a display program that enable improving operability of a user's input operation.

A display device according to one aspect of the present disclosure is a display device that accepts a non-contact input operation of a user directed to a display screen. The display device includes: a gesture operation detector that detects a predetermined gesture operation of the user; an operation area setter that sets, when the gesture operation detector detects a first gesture operation of the user, an area associated with the first gesture operation, as a virtual operation area that accepts the input operation of the user directed to the display screen; an input operation detector that detects the input operation of the user; and an input processor that executes, when the input operation detector detects the input operation of the user in the virtual operation area set by the operation area setter, input processing according to the input operation of the user directed to the display screen.

A display method according to another aspect of the present disclosure is a display method of accepting a non-contact input operation of a user directed to a display screen. The method includes: by one or more processors, detecting a predetermined gesture operation of the user; when a first gesture operation of the user is detected in the gesture operation detecting, setting an area associated with the first gesture operation, as a virtual operation area that accepts the input operation of the user directed to the display screen; detecting the input operation of the user; and, in the input operation detecting, when the input operation of the user is detected in the virtual operation area having been set, executing input processing according to the input operation of the user directed to the display screen.

A recording medium according to another aspect of the present disclosure is a recording medium recording a display program that accepts a non-contact input operation of a user directed to a display screen. The program causes one or more processors to execute: a gesture operation detecting step of detecting a predetermined gesture operation of the user; an operation area setting step of setting, when a first gesture operation of the user is detected in the gesture operation detecting step, an area associated with the first gesture operation, as a virtual operation area that accepts the input operation of the user directed to the display screen; an input operation detecting step of detecting the input operation of the user; and an input step of executing input processing according to the input operation of the user directed to the display screen, in the input operation detecting step, when the input operation of the user is detected in the virtual operation area set in the operation area setting step.

According to the present disclosure, it is possible to improve operability of a user's input operation in a display device that accepts a non-contact input operation of the user directed to a display screen.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a configuration of a display device according to an embodiment of the present disclosure.

FIG. 2 is a schematic diagram illustrating an example of a virtual operation area in the display device according to the embodiment of the present disclosure.

FIG. 3 is a diagram illustrating an example of a setting method of a virtual operation area in the display device according to the embodiment of the present disclosure.

FIG. 4 is a diagram illustrating an example of a setting method of a virtual operation area in the display device according to the embodiment of the present disclosure.

FIG. 5 is a diagram illustrating an example of a setting method of a virtual operation area in the display device according to the embodiment of the present disclosure.

FIG. 6 is a diagram illustrating an example of a setting method of a virtual operation area in the display device according to the embodiment of the present disclosure.

FIG. 7 is a diagram illustrating an example of a setting method of a virtual operation area in the display device according to the embodiment of the present disclosure.

FIG. 8 is a diagram illustrating an example of a setting method of a virtual operation area in the display device according to the embodiment of the present disclosure.

FIG. 9 is a diagram illustrating an example of a setting method of a virtual operation area in the display device according to the embodiment of the present disclosure.

FIG. 10 is a diagram illustrating an example of a setting method of a virtual operation area in the display device according to the embodiment of the present disclosure.

FIG. 11 is a diagram illustrating an example of a setting method of a virtual operation area in the display device according to the embodiment of the present disclosure.

FIG. 12 is a flowchart illustrating an example of a procedure of display control processing to be performed by the display device according to the embodiment of the present disclosure.

### DETAILED DESCRIPTION

In the following, an embodiment according to the present disclosure is described with reference to the accompanying drawings. Note that, the following embodiment is an example embodying the present disclosure, and does not limit the technical scope of the present disclosure.

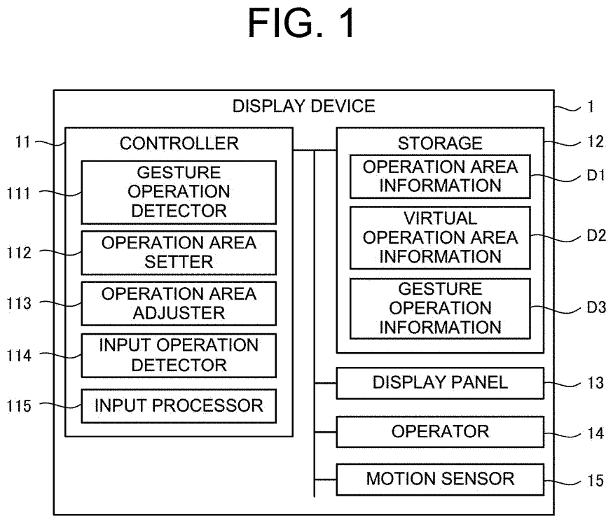

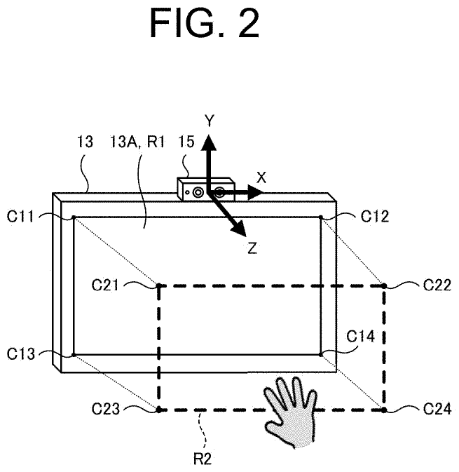

As illustrated in FIG. 1, a display device 1 according to an embodiment of the present disclosure includes a controller 11, a storage 12, a display panel 13, an operator 14, and a motion sensor 15. FIG. 2 illustrates a schematic diagram of the display device 1. The motion sensor 15 is installed on an upper portion of the display panel 13, and detects a predetermined gesture operation and an input operation of the user.

The display device 1 accepts a non-contact input operation of the user directed to a display screen 13A. For example, when detecting a predetermined gesture operation of the user, the display device 1 sets an area associated with the gesture operation, as a virtual operation area R2 (see FIG. 2) that accepts the input operation of the user directed to the display screen 13A. The user performs a touch operation (input operation) in the virtual operation area R2. When detecting the user's input operation in the virtual operation area R2, the display device 1 performs input processing according to the user's input operation directed to the display screen 13A. For example, when the user touches a predetermined position in the virtual operation area R2, the display device 1 detects a position on the display screen 13A, which is associated with the touch position in the virtual operation area R2, and accepts the touch input. In the following, a specific configuration of the display device 1 is described.

The motion sensor 15 includes, for example, two cameras and three infrared LEDs, and detects the gesture operation and the input operation of the user in a predetermined detection range. The motion sensor 15 outputs detection information to the controller 11. The detection information includes position coordinates (X coordinates, Y coordinates, and Z coordinates) of an object (e.g., a user's hand) to be detected by the motion sensor 15. The motion sensor 15 is capable of detecting, for example, the back (palm), finger joints, and fingertips of the user's hand (right hand RH, left hand LH). A well-known technique can be applied to the motion sensor 15.

The display panel 13 is a display that displays an image, and is, for example, a liquid crystal display. The operator 14 is an operation device such as a mouse and a keyboard. The operator 14 may be constituted of a touch panel.

The storage 12 is a non-volatile storage such as a hard disk drive (HDD) or a solid state drive (SSD) that stores various pieces of information. Specifically, the storage 12 stores data such as operation area information D1, virtual operation area information D2, and gesture operation information D3.

The operation area information D1 is information indicating an operation area R1 in the display screen 13A of the display panel 13. The operation area R1 is an area on the display screen 13A in which the user can perform an input operation via the virtual operation area R2, specifically, an area capable of accepting a user's input operation. The operation area R1 may be set in the entire area of the display screen 13A or in a part of the display screen 13A. For example, in a case where the entire area of the display screen 13A is set as the operation area R1, the operation area information D1 includes information on coordinates C11 to C14 (see FIG. 2) of four corners of the display screen 13A, as coordinate information that defines the operation area R1. The operation area information D1 is registered in the storage 12 each time the operation area R1 is set or updated.

The virtual operation area information D2 is information indicating the virtual operation area R2 that accepts the user's input operations directed to the display screen 13A. Specifically, the virtual operation area R2 is associated with the operation area R1, and coordinates C21 to C24 (see FIG. 2) of four corners that define the virtual operation area R2 are associated with the coordinates C11 to C14 that define the operation area R1. The virtual operation area information D2 includes information on the coordinates C21 to C24 of the four corners that define the virtual operation area R2. The virtual operation area information D2 is registered in the storage 12 each time the virtual operation area R2 is set or updated. The user can set the virtual operation area R2 of a desired size at a desired position by performing a predetermined gesture operation to be described later.

The gesture operation information D3 is information on a predetermined gesture operation by the user. For example, the gesture operation information D3 includes information on a plurality of specific gesture operations such as an operation of holding the user's left hand (operation of holding the palm of the left hand), an operation of holding the right hand (operation of holding the palm of the right hand), an operation of clenching the fist of the left hand (operation of clenching the left hand), an operation of clenching the fist of the right hand (operation of clenching the right hand), a pointing operation by the right hand (pointing operation by the index finger of the right hand), a pointing operation by the left hand (pointing operation by the index finger of the left hand), and the like. The gesture operation information D3 is registered in the storage 12 in advance.

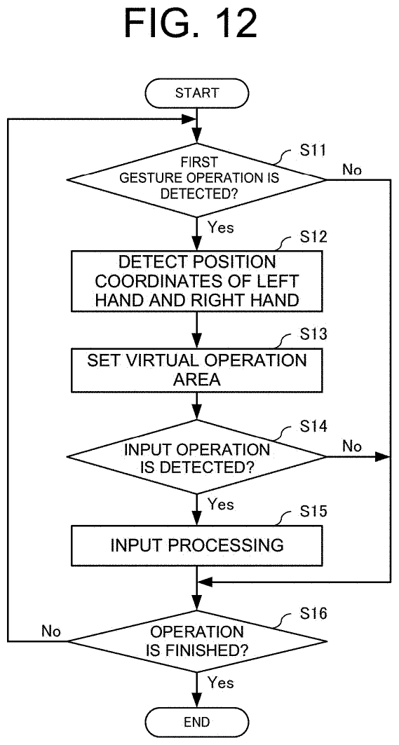

In addition, the storage 12 stores a control program such as a display control program for causing the controller 11 to execute display control processing (see FIG. 12) to be described later. For example, the display control program is non-transitorily recorded on a computer-readable recording medium such as a CD or a DVD, read by a reading device (not illustrated) such as a CD drive or a DVD drive provided in the display device 1, and stored in the storage 12. Note that, the display control program may be distributed from a cloud server and stored in the storage 12.

The controller 11 includes a control device such as a CPU, a ROM, and a RAM. The CPU is a processor that executes various arithmetic processing. The ROM is a non-volatile storage in which a control program such as a BIOS and an OS for causing the CPU to execute various arithmetic processing is stored in advance. The RAM is a volatile or non-volatile storage that stores various pieces of information, and is used as a temporary storage memory (work area) in which the CPU executes various processing. The controller 11 controls the display device 1 by causing the CPU to execute various control programs stored in advance in the ROM or the storage 12.

Specifically, as illustrated in FIG. 1, the controller 11 includes various processors such as a gesture operation detector 111, an operation area setter 112, an operation area adjuster 113, an input operation detector 114, and an input processor 115. Note that, the controller 11 functions as the gesture operation detector 111, the operation area setter 112, the operation area adjuster 113, the input operation detector 114, and the input processor 115 by causing the CPU to execute various processing according to the display control program. Also, a part or all of the processors included in the controller 11 may be constituted of an electronic circuit. Note that, the display control program may be a program for causing a plurality of processors to function as the various processors described above.

The gesture operation detector 111 detects a gesture operation of a user. Specifically, the gesture operation detector 111 detects the gesture operation, based on detection information to be acquired from the motion sensor 15. For example, the gesture operation detector 111 determines an associated gesture operation among a plurality of gesture operations registered in the gesture operation information D3 by determining the shape of the user's hand, based on coordinate information included in the detection information. The gesture operation detector 111 also detects a gesture operation (an example of a third gesture operation according to the present disclosure), such as a touch input operation with respect to an image displayed on the display screen 13A, and a drawing operation in the virtual operation area R1.

The operation area setter 112 sets a virtual operation area R2. Specifically, when the gesture operation detector 111 detects a predetermined first gesture operation (a first gesture operation according to the present disclosure) of the user, the operation area setter 112 sets an area associated with the first gesture operation, as the virtual operation area R2 that accepts a user's input operation directed to the display screen 13A. Note that, the operation area setter 112 may set the virtual operation area R2 when the first gesture operation is performed continuously for a predetermined time. The first gesture operation is, for example, an operation of holding the palm of each of the left hand LH and the right hand RH toward the display screen 13A. Specifically, the first gesture operation is a setting operation for the user to set the virtual operation area R2.

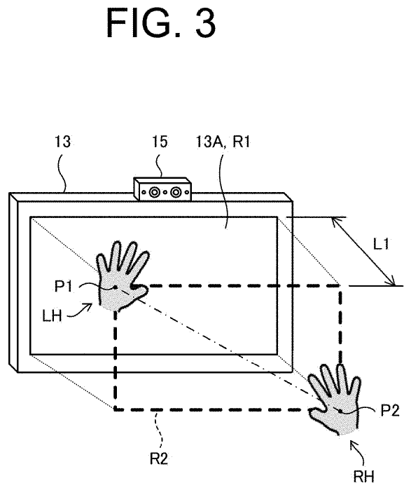

For example, as illustrated in FIG. 3, when the user holds the palm of his/her left hand LH toward the display screen 13A at any position in an upper left space, and holds the palm of his/her right hand RH toward the display screen 13A at any position in a lower right space, the gesture operation detector 111 detects, based on detection information to be acquired from the motion sensor 15, a coordinate P1 of the left hand LH, a coordinate P2 of the right hand RH, and a first gesture operation of holding the left hand LH and the right hand RH. When the gesture operation detector 111 detects the first gesture operation, the operation area setter 112 sets the virtual operation area R2, based on the coordinate P1 of the left hand LH and the coordinate P2 of the right hand RH detected by the gesture operation detector 111.

For example, as illustrated in FIG. 3, the operation area setter 112 sets the rectangular virtual operation area R2 having a line connecting a position (coordinate P1) of the left hand LH and a position (coordinate P2) of the right hand RH as a diagonal line. Specifically, the operation area setter 112 sets the virtual operation area R2 by calculating the coordinates C21 to C24 (see FIG. 2) of the corners of the rectangle, based on the coordinate P1 of the left hand LH and the coordinate P2 of the right hand RH.

For example, the operation area setter 112 sets the virtual operation area R2 at a position away from the display screen 13A by a predetermined distance L1. Note that, the predetermined distance L1 is a distance associated with the coordinate P1 (Z coordinate) of the left hand LH and the coordinate P2 (Z coordinate) of the right hand RH.

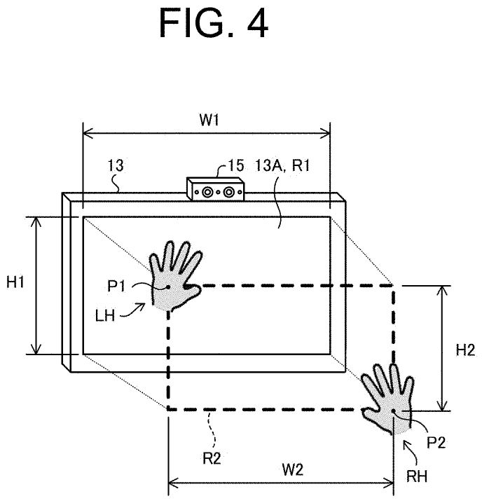

For example, the operation area setter 112 may set a virtual operation area R2 whose aspect ratio is the same as the aspect ratio of the display screen 13A. Specifically, as illustrated in FIG. 4, the operation area setter 112 sets the virtual operation area R2 in which the aspect ratio (H1:W1) of the display screen 13A and the aspect ratio (H2:W2) of the virtual operation area R2 are the same (H1:W1=H2:W2).

Thus, the size (operation area R1) of the display screen 13A and the size of the virtual operation area R2 may be the same or different. Herein, in a case where the virtual operation area R2 is smaller than the operation area R1, it is suitable for an application in which a large display panel 13 is operated at a user's hand. In contrast, in a case where the virtual operation area R2 is larger than the operation area R1, it is suitable for an application in which a small display panel 13 is operated at a remote location.

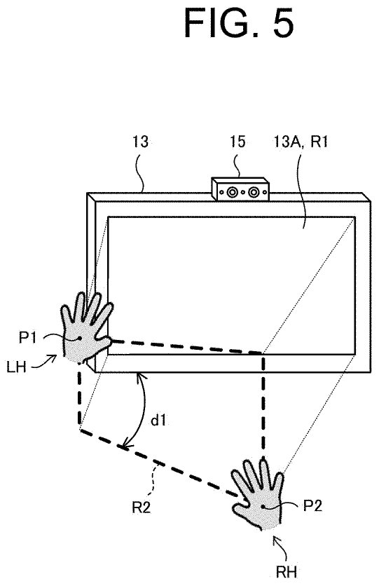

As illustrated in FIG. 5, the operation area setter 112 may set a virtual operation area R2 having a predetermined angle d1, which is not parallel to the display screen 13A. Specifically, the virtual operation area R2 may be set obliquely directed to the display screen 13A. For example, the operation area setter 112 sets the predetermined angle d1, based on the coordinate P1 (Z coordinate) of the left hand LH and the coordinate P2 (Z coordinate) of the right hand RH. This allows for the user to perform an input operation obliquely directed to the display screen 13A. Note that, the operation area setter 112 may cause the display screen 13A to display information on the predetermined angle d1. This allows for the user to recognize the angle (degree of inclination) of the virtual operation area R2 directed to the display screen 13A.

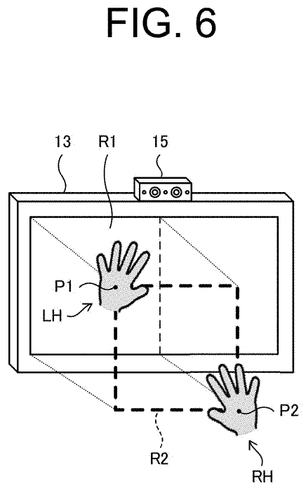

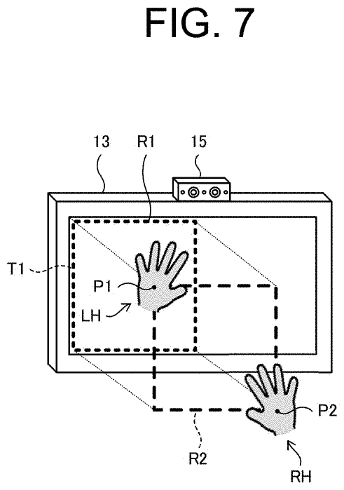

The operation area setter 112 may set a virtual operation area R2 associated with an area being a part of the display screen 13A. For example, as illustrated in FIG. 6, the operation area setter 112 sets a virtual operation area R2 associated with an operation area R1 being a part (left side area) of the display screen 13A. A position and a size of the operation area R1 can be set by a user's setting operation. Note that, the operation area setter 112 may cause the display screen 13A to display an object image T1 (an example of a first object image according to the present disclosure) indicating the operation area R1, as illustrated in FIG. 7, in such a way that the user who sets the virtual operation area R2 can easily recognize the operation area R1, when setting the virtual operation area R2.

Note that, the operation area setter 112 can set the virtual operation area R2, which is provided in association with the operation area R1 on the display screen 13A, based on a coordinate associated with a first gesture operation by using well-known coordinate transformation (projective transformation, affine transformation, and the like).

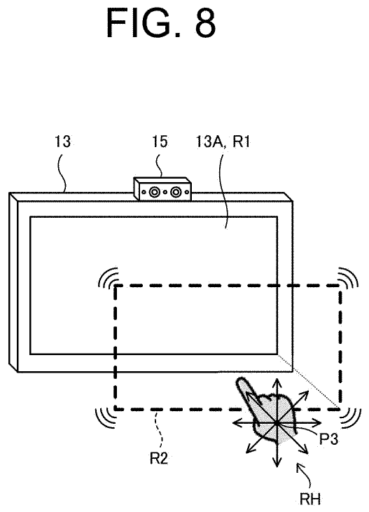

The operation area adjuster 113 adjusts the virtual operation area R2 to be set by the operation area setter 112. Specifically, when the gesture operation detector 111 detects a predetermined second gesture operation (a second gesture operation according to the present disclosure) of the user after the virtual operation area R2 is set, the operation area adjuster 113 changes at least one of a size and a position of the virtual operation area R2, based on the second gesture operation. The second gesture operation is, for example, a pointing operation by the right hand RH (see FIG. 8).

For example, as illustrated in FIG. 8, when the user points and operates the display screen 13A with his/her right hand RH after the virtual operation area R2 is set, the gesture operation detector 111 detects, based on detection information to be acquired from the motion sensor 15, a coordinate P3 of the right hand RH and a second gesture operation being a pointing operation by the right hand RH. When the gesture operation detector 111 detects the second gesture operation, the operation area adjuster 113 sets the virtual operation area R2 to be movable based on the coordinate P3 of the right hand RH detected by the gesture operation detector 111, and accepts a moving operation of the virtual operation area R2 by the user. For example, when the user moves his/her right hand RH in a left direction in a pointing state, the operation area adjuster 113 moves the virtual operation area R2 in the left direction by an amount corresponding to an amount of movement of the right hand RH. Specifically, the operation area adjuster 113 sets the virtual operation area R2 at the coordinate P3 of the right hand RH after the movement.

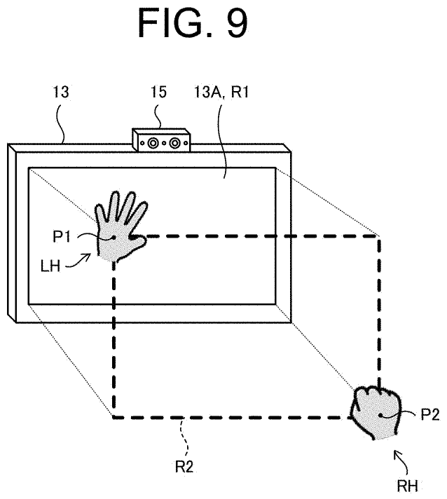

For example, as illustrated in FIG. 9, when the user performs an operation of clenching the fist of the right hand RH while holding his/her left hand LH after the virtual operation area R2 is set, the gesture operation detector 111 detects, based on detection information to be acquired from the motion sensor 15, the coordinate P1 of the left hand LH, the coordinate P2 of the right hand RH, and a second gesture operation of clenching the right hand RH while holding the left hand LH. When the gesture operation detector 111 detects the second gesture operation, the operation area adjuster 113 sets a size of the virtual operation area R2 to be changeable based on the coordinate P2 of the right hand RH detected by the gesture operation detector 111, and accepts an operation of changing the size of the virtual operation area R2 by the user. For example, when the user moves his/her right hand RH in a lower right direction, while clenching the fist, the operation area adjuster 113 expands the size (area) of the virtual operation area R2 by an amount corresponding to an amount of movement of the right hand RH. Specifically, the operation area adjuster 113 sets the virtual operation area R2 to be defined by the coordinate P1 of the left hand LH and the coordinate P2 of the right hand RH after the movement.

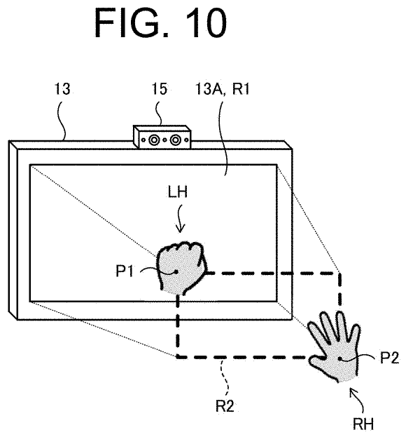

The example illustrated in FIG. 10 shows an example in a case where the user performs an operation of clenching the fist of his/her left hand LH, while holding his/her right hand RH after the virtual operation area R2 is set. In this case, the gesture operation detector 111 detects, based on detection information to be acquired from the motion sensor 15, the coordinate P1 of the left hand LH, the coordinate P2 of the right hand RH, and a second gesture operation of clenching the left hand LH while holding the right hand RH. When the gesture operation detector 111 detects the second gesture operation, the operation area adjuster 113 sets a size of the virtual operation area R2 to be changeable based on the coordinate P1 of the left hand LH detected by the gesture operation detector 111, and accepts an operation of changing the size of the virtual operation area R2 by the user. For example, when the user moves his/her left hand LH in a lower right direction while clenching the fist, the operation area adjuster 113 reduces the size (area) of the virtual operation area R2 by an amount corresponding to an amount of movement of the left hand LH. Specifically, the operation area adjuster 113 sets the virtual operation area R2 to be defined by the coordinate P2 of the right hand RH and the coordinate P1 of the left hand LH after the movement.

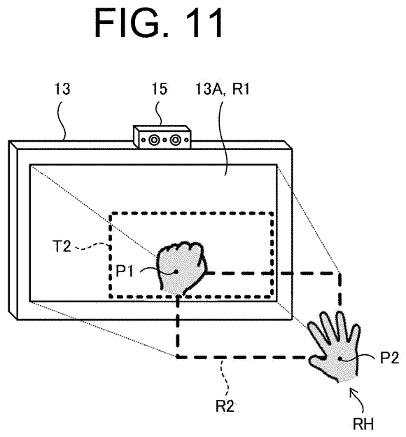

Note that, in a case where the gesture operation detector 111 detects the second gesture operation after the virtual operation area R2 is set, the operation area adjuster 113 may cause the display screen 13A to display an object image T2 (an example of a second object image according to the present disclosure) indicating the virtual operation area R2 according to the second gesture operation. FIG. 11 illustrates an example of the object image T2 indicating the virtual operation area R2 after the size is changed. In this configuration, the user can visually recognize a size, a position, and the like of the virtual operation area R2 after the changing.

The input operation detector 114 detects a user's input operation. Specifically, the input operation detector 114 detects a user's input operation in the virtual operation area R2 set by the operation area setter 112. For example, the input operation detector 114 detects a detection coordinate in the virtual operation area R2, based on detection information to be acquired from the motion sensor 15, and calculates an input coordinate in the operation area R1 from the detection coordinate. The input operation is a touch input operation with respect to an image displayed on the display screen 13A, and is an example of a third gesture operation according to the present disclosure.

Herein, when it is assumed that a ratio of the virtual operation area R2 to the operation area R1 is “W2:W1=H2:H1=a:b” (see FIG. 4), the input operation detector 114 can calculate an input coordinate [dx, dy], based on a detection coordinate [sx, sy] in the virtual operation area R2 by a formula: dx=sx×b/a and dy=sy×b/a. Note that, display resolution [rx, ry] is Min [dx, dy]=[0, 0], and Max [dx, dy]=[dx, dy].

When the input operation detector 114 detects the input operation (third gesture operation) of the user in the virtual operation area R2, the input processor 115 executes input processing according to the user's input operation directed to the display screen 13A. For example, when the input operation detector 114 detects a user's touch operation with respect to an object image displayed on the display screen 13A in the virtual operation area R2, the input processor 115 detects a position on the display screen 13A associated with the touch position, and accepts the touch input.

Display Control Processing

In the following, display control processing to be executed by the controller 11 of the display device 1 is described referring to FIG. 12.

Note that, the present disclosure can be described as a disclosure of a display control method (an example of a display method according to the present disclosure) in which one or more steps included in the display control processing are executed, and one or more steps included in the display control processing described herein may be omitted as necessary. Note that, the order of execution of each step in the display control processing may be different, as far as similar advantageous effects are generated. Furthermore, although a case where the controller 11 executes each step in the display control processing is described herein as an example, a display control method in which a plurality of processors execute each step in the display control processing in a distributed manner is also considered as another embodiment.

First, in step S11, the controller 11 determines whether a predetermined first gesture operation is detected. The first gesture operation is, for example, an operation (setting operation) of holding the palm of each of the left hand LH and the right hand RH toward the display screen 13A (see FIG. 3). When the controller 11 detects the first gesture operation (S11: Yes), the processing proceeds to step S12. In a case where the controller 11 does not detect the first gesture operation (S11: No), the processing proceeds to step S16. Step S11 is an example of a gesture operation detecting step according to the present disclosure.

In step S12, the controller 11 detects a position coordinate associated with the first gesture operation. Herein, the controller 11 detects coordinates P1 and P2 (see FIG. 3) of the left hand LH and the right hand RH, respectively.

Next, in step S13, the controller 11 sets a virtual operation area R2. For example, the controller 11 sets, as the virtual operation area R2, a rectangle having a straight line connecting the coordinates P1 and P2 of the left hand LH and the right hand RH respectively detected in step S12, as a diagonal line, at a position away from the display screen 13A by the predetermined distance L1 (see FIG. 3). Step S13 is an example of an operation area setting step according to the present disclosure.

Next, in step S14, the controller 11 determines whether a user's input operation is detected. Specifically, the controller 11 detects the user's input operation in the virtual operation area R2. For example, the controller 11 detects a detection coordinate in the virtual operation area R2, based on detection information to be acquired from the motion sensor 15, and calculates an input coordinate in the operation area R1 on the display screen 13A from the detection coordinate. When the controller 11 detects the input operation (S14: Yes), the processing proceeds to step S15. When the controller 11 does not detect the input operation (S14: No), the processing proceeds to step S16. Step S14 is an example of an input operation detecting step according to the present disclosure.

In step S15, the controller 11 performs input processing according to the user's input operation directed to the display screen 13A. For example, when the controller 11 detects a touch operation of the user with respect to an object image displayed on the display screen 13A in the virtual operation area R2, the controller 11 detects a position associated with the touch position on the display screen 13A, and accepts the touch input. Step S15 is an example of an input step according to the present disclosure.

In step S16, the controller 11 determines whether various operations with respect to the display device 1 have been completed. The operations include a predetermined gesture operation, an input operation, and the like by the user. When the operations have been completed (S16: Yes), the controller 11 finishes the display control processing. When the operation are not finished (S16: No), the controller 11 returns to step S11 and repeats the above-described processing.

As described above, the display device 1 according to the present embodiment is a display device that accepts a non-contact input operation of a user directed to the display screen 13A. Also, when detecting a predetermined first gesture operation of the user, the display device 1 sets an area associated with the first gesture operation, as the virtual operation area R2 that accepts the user's input operation directed to the display screen 13A. Then, when detecting the user's input operation in the virtual operation area R2, the display device 1 executes input processing according to the user's input operation directed to the display screen 13A.

In this configuration, it is possible to set the virtual operation area R2 of a desired size at a desired position of the user. Also, the user can set the virtual operation area R2 obliquely directed to the display screen 13A, and can change the position and the size of the set virtual operation area R2. Thus, it is possible to improve operability of the user's input operation.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. A display device that accepts a non-contact input operation of a user directed to a display screen, comprising:
a gesture operation detector that detects a predetermined gesture operation of the user;
an operation area setter that sets, when the gesture operation detector detects a first gesture operation of the user, an area associated with the first gesture operation, as a virtual operation area that accepts the input operation of the user directed to the display screen;
an input operation detector that detects the input operation of the user; and
an input processor that executes, when the input operation detector detects the input operation of the user in the virtual operation area set by the operation area setter, input processing according to the input operation of the user directed to the display screen.

2. The display device according to claim 1, wherein
the operation area setter sets the virtual operation area at a position away from the display screen by a predetermined distance, associated with the first gesture operation.

3. The display device according to claim 2, wherein
the operation area setter sets the virtual operation area whose aspect ratio is the same as an aspect ratio of the display screen.

4. The display device according to claim 2, wherein
the operation area setter sets the virtual operation area having a predetermined angle that is not parallel to the display screen.

5. The display device according to claim 2, wherein
the operation area setter sets the virtual operation area associated with an area being a part of the display screen.

6. The display device according to claim 5, wherein
the operation area setter causes the display screen to display a first object image indicating an area being a part of the display screen.

7. The display device according to claim 1, wherein
the first gesture operation includes an operation of holding the left hand of the user and an operation of holding the right hand of the user, and
the operation area setter sets the virtual operation area of a rectangle having, as a diagonal line, a line connecting a position of the left hand and a position of the right hand.

8. The display device according to claim 1, further comprising
an operation area adjuster that adjusts the virtual operation area to be set by the operation area setter, wherein
when the gesture operation detector detects a second gesture operation of the user after the virtual operation area is set, the operation area adjuster changes at least one of a size and a position of the virtual operation area, based on the second gesture operation.

9. The display device according to claim 8, wherein
when the gesture operation detector detects the second gesture operation after the virtual operation area is set, the operation area adjuster causes the display screen to display a second object image indicating the virtual operation area according to the second gesture operation.

10. The display device according to claim 1, wherein
when the input operation detector detects a third gesture operation of the user in the virtual operation area set by the operation area setter, the input processor determines that the third gesture operation is the input operation, and executes input processing according to the third gesture operation.

11. A display method of accepting a non-contact input operation of a user directed to a display screen, the method comprising:
by one or more processors,
detecting a predetermined gesture operation of the user;
when a first gesture operation of the user is detected in the gesture operation detecting, setting an area associated with the first gesture operation, as a virtual operation area that accepts the input operation of the user directed to the display screen;
detecting the input operation of the user; and
in the input operation detecting, when the input operation of the user is detected in the virtual operation area having been set, executing input processing according to the input operation of the user directed to the display screen.

12. A non-transitory computer-readable recording medium recording a display program that accepts a non-contact input operation of a user directed to a display screen, the display program causing one or more processors to execute:
a gesture operation detecting step of detecting a predetermined gesture operation of the user;
an operation area setting step of setting, when a first gesture operation of the user is detected in the gesture operation detecting step, an area associated with the first gesture operation, as a virtual operation area that accepts the input operation of the user directed to the display screen;
an input operation detecting step of detecting the input operation of the user; and
an input step of executing input processing according to the input operation of the user directed to the display screen, in the input operation detecting step, when the input operation of the user is detected in the virtual operation area set in the operation area setting step.
